(19) United States
(12) Patent Application Publication
(10) Pub. No.: US 2018/0347662 A1
(43) Pub. Date: Dec. 6, 2018

(54) PENDULUM TORSIONAL-VIBRATION REDUCING DEVICE

(71) Applicant: TOYOTA JIDOSHA KABUSHIKI KAISHA, Toyota-shi (JP)

(72) Inventors: Toyoaki IWANE, Nisshin-shi (JP); Yuji SUZUKI, Kariya-shi (JP); Hiroyuki AMANO, Susono-shi (JP); Yu MIYAHARA, Susono-shi (JP); Shuhei HORITA, Numazu-shi (JP)

(73) Assignee: TOYOTA JIDOSHA KABUSHIKI KAISHA, Toyota-shi (JP)

(21) Appl. No.: 15/965,126

(22) Filed: Apr. 27, 2018

(30) Foreign Application Priority Data
Jun. 6, 2017 (JP) 2017-111879

(51) Int. Cl. F16F 15/14

(52) U.S. Cl. CPC F16F 15/145; F16H 45/02

(57) ABSTRACT

A pendulum torsional-vibration reducing device includes: a rotor having a plurality of through-holes formed in the rotor with predetermined intervals in a circumferential direction of the rotor; a rolling element disposed in the through-holes so as to carry out pendular movement; and a casing fixed to the rotor so as to cover the rolling element, wherein the casing includes fixing pieces in tight contact with both side surfaces of the rotor so as to hold the rotor therebetween, and a thickness of the rotor at a position where the fixing pieces are in tight contact is thinner than a thickness of the rotor at a position where a rolling surface to which the rolling element is pushed by centrifugal force is formed.

### INCORPORATION BY REFERENCE

The disclosure of Japanese Patent Application No. 2017-111879 filed on Jun. 6, 2017 including the specification, drawings and abstract is incorporated herein by reference in its entirety.

### BACKGROUND

### 1. Technical Field

This disclosure relates to a device for reducing torsional vibrations by reciprocating movement or pendulum movement of a rolling element.

### 2. Description of Related Art

A torsional-vibration reducing device installed in a torque converter is described in Japanese Patent Application Publication No. 2016-011668. The torsional-vibration reducing device described JP 2016-011668 A is configured such that the torsional-vibration reducing device includes a rotor and a rolling element, and the rolling element moves along a rolling surface formed to the rotor while performing pendular movement, to thereby reduce torsional vibrations of the rotor. In the above rolling element, the rolling element and a region where this rolling element performs the pendular movement are sealed in a liquid tight condition by a casing so that the pendular movement of the rolling element is not hindered by fluid inside the torque converter. This casing is composed by a first case member and a second case member, and covers the rolling element with the first and the second case members so as not to be in contact with the rolling element. In addition, an inner circumferential part of the casing is in tight contact with the rotor along a side surface of the rotor, and in this state, the two case members and the rotor are fastened by a rivet extending through the two case members and the rotor. A seal member is interposed between the case members and the rotor so as to maintain the inside of the casing in a liquid tight condition relative to the fluid outside the casing.

### SUMMARY

In the device described in JP 2016-011668 A, the rolling element performs the pendular movement along the rolling surface formed to the rotor so as to reduce the torsional movement of the rotor. Hence, a thickness of the roller at a position where the rolling surface is formed is set to be a contact area or a contact width when the rolling element performs the pendular movement along the rolling surface, and thus a surface pressure due to this contact is lowered, to thereby suppress an unexpected deformation, such as buckling. In the meantime, in the device described in JP 2016-011668 A, a thickness of the rotor at the position where the rolling surface is formed and a thickness of the rotor at the position where the seal member is provided are set to be the same. This means that the thickness at the position where the seal member is provided is not less than a thickness for securing the sealing property; therefore, the weight of the rotor becomes heavier, and a thickness of a riveted portion of the rotor with the seal member interposed therebetween and a thickness at a position of the rotor where the casing is fastened become thicker. That is, an axial length of the rivet becomes longer, and thus the cost is increased and an entire axial length of the device becomes longer by that increased length.

As aforementioned, as the mass of the rotor is greater, a ratio of the rolling element as an inertial mass body relative to the total mass of the torsional-vibration reducing device becomes smaller; consequently, the vibration reducing performance might be deteriorated, and thus there is still room for improvement.

This disclosure provides a pendulum torsional-vibration reducing device reducing a total mass of the device as well as enhancing the vibration reducing performance.

An aspect of the present disclosure is related to a pendulum torsional-vibration reducing device including: a rotor that is rotatable, the rotor having a plurality of through-holes formed in the rotor, the plurality of through-holes being formed with predetermined intervals in a circumferential direction of the rotor; a rolling element disposed in the through-holes so as to carry out pendular movement; and a casing fixed to the rotor so as to cover the rolling element, wherein: the casing includes fixing pieces, the fixing pieces being in tight contact with both side surfaces of the rotor so as to hold the rotor between the fixing pieces; the rotor has a rolling surface against which the rolling element is pushed by centrifugal force; the rotor includes a first portion where the rolling surface is formed, and a second portion with which the fixing pieces are in tight contact; and a thickness at the second portion is thinner than a thickness at the first portion.

With the pendulum torsional-vibration reducing device of the above aspect, since the thickness of the rotor at the position in tight contact with and held between the fixing pieces is thinner as described above, it is possible to reduce the total mass of the pendulum torsional-vibration reducing device by the reduced thickness of the rotor. In other words, the ratio of the rolling element as an inertial mass body relative to the total mass of the pendulum torsional-vibration reducing device becomes increased; and as a result, it is possible to enhance the vibration reducing performance.

The pendulum torsional-vibration reducing device according to the above aspect may further comprise a fastening member that fixes the fixing pieces to the rotor, wherein: the fastening member may extend through the fixing pieces and the rotor in a thickness direction; and the fastening member may integrally fasten the fixing pieces and the rotor all together.

With the pendulum torsional-vibration reducing device of the above aspect, it is configured that the thickness of the rotor at the position of the rolling surface is different from the thickness of the rotor at the position in tight contact with and held between the fixing pieces of the casing, and the thickness is thinner at the position in tight contact with and held between the fixing pieces. That is, because the rolling element is pushed against the rolling surface where the rolling element rolls by centrifugal force due to the rotation of the rotor, the thickness of the rotor at the position of the rolling surface is set to be thicker. In the meantime, because force such as centrifugal force is not directly applied to the rotor at the position held between the fixing pieces of the casing, the thickness of the rotor at the position held between the fixing pieces is set to be thinner than the thickness of the rotor at the position where the rolling surface is formed. Hence, according to this disclosure, since the thickness of the rotor at the position in tight contact with and held between the fixing pieces is thinner, it is possible to set the length of the fastening member (such as a rivet and a bolt) to fasten the casing and the rotor to be shorter.

Further, by reducing the length of the fastening member in the above manner, it is possible to attain cost reduction as well as weight reduction of the fastening member; and in addition to this, it is possible to reduce the entire axial length of the pendulum torsional-vibration reducing device.

In the pendulum torsional-vibration reducing device according to the above aspect, at a position where the fixing pieces and the rotor are integrally fastened by the fastening member, a total thickness of a thickness of the fixing pieces and a thickness of the rotor may be thicker than the thickness at the first portion

In the pendulum torsional-vibration reducing device according to the above aspect, a seal member may be interposed between the fixing pieces and the rotor, and the seal member may seal a part between the fixing pieces and the rotor.

In the pendulum torsional-vibration reducing device according to the above aspect, the rolling element may include a shaft portion and a flange portion, a length of the shaft portion may be larger or equal to the thickness at the first portion, the flange portion may be at least provided at one end of the shaft portion, an outer diameter of each flange portion may be greater than an outer diameter of the shaft portion, and in an outward portion being a portion of the rotor located more circumferentially outward than the first portion, a thickness of a part of the outward portion where the rotor and the flange portion do not overlap with each other may be thinner in an axial direction of the rotor than the thickness at the first portion.

With the pendulum torsional-vibration reducing device of the above aspect, by setting the thickness of a part of the outward portion where the rotor and the flange portion do not overlap with each other to be thinner, even when the rolling element vibrates or is inclined in the thickness direction of the rotor, it is possible to suppress the contact between the rotor and the rolling element. Therefore, it is possible to suppress hindrance of the pendular movement of the rolling element and deterioration of the vibration reducing performance.

In the pendulum torsional-vibration reducing device according to the above aspect, in an inward portion being a portion of the rotor located more circumferentially inward than the through-holes, a part of the inward portion where the rotor and the flange portion do not overlap with each other may have a thickness gradually thinner toward a radially inward direction of the rotor.

With the pendulum torsional-vibration reducing device of the above aspect, since the thickness of the rotor becomes gradually thinner, stress concentration in the rotor can be prevented. Therefore, bending or buckling caused by the stress concentration can be suppressed, and durability can be enhanced.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic view schematically showing a structure of a torque converter in which a pendulum torsional-vibration reducing device in embodiments of this disclosure is accommodated;

FIG. 2 is a view explaining a pendulum torsional-vibration reducing device in a first embodiment of this disclosure;

FIG. 3 is a view explaining a pendulum torsional-vibration reducing device in a second embodiment of this disclosure; and

FIG. 4 is a view explaining a pendulum torsional-vibration reducing device in a variation of this disclosure.

### DETAILED DESCRIPTION OF EMBODIMENTS

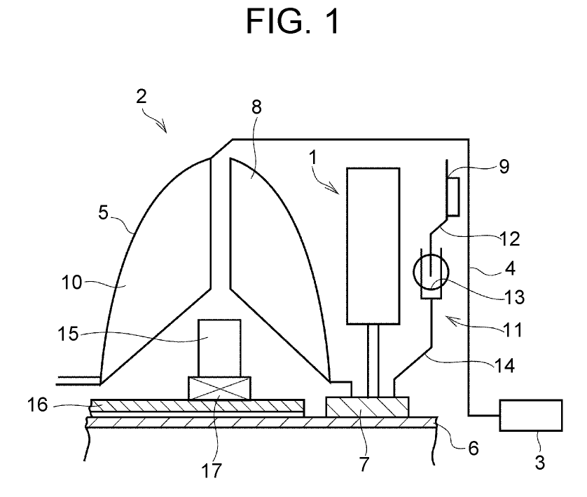

Hereinafter, this disclosure will be specifically described with reference to the drawings. A pendulum torsional-vibration reducing device 1 according to this disclosure is installed in a torque converter 2, as shown in FIG. 1. The configuration of the torque converter 2 will be simply described below. A front cover 4 coupled to an engine 3, and a pump shell 5 are integrated to each other, and are formed as a housing for the entire torque converter 2. An input shaft 6 of a transmission mechanism is arranged along a central axis of this housing. A turbine hub 7 is provided to an outer circumference of the input shaft 6 so as to integrally rotate with the input shaft 6. A turbine runner 8, a lock-up clutch 9, and the pendulum torsional-vibration reducing device 1 are coupled to the turbine hub 7.

The turbine runner 8 is disposed to face a pump impeller 10, and is configured to rotate by receiving an oil flow generated by the pump impeller 10. The lock-up clutch 9 is disposed to face an inner surface of the front cover 4, and is configured such that the lock-up clutch 9 is pushed against the front cover 4 by oil pressure to come into an engagement state in which torque can be transmitted, and when the oil pressure is lowered and the lock-up clutch 9 comes apart from the front cover 4, the lock-up clutch 9 comes out of the engagement state so that no torque is transmitted. This lock-up clutch 9 is coupled to the turbine hub 7 via a lock-up damper 11 that performs buffering by using an elastic force of a coil spring. This lock-up damper 11 includes: a drive-side member 12 coupled to the lock-up clutch 9; and a driven-side member 14 coupled to this drive-side member 12 via a coil spring 13, and the driven-side member 14 is coupled to the turbine hub 7. The drive-side member 12 and the driven-side member 14 are annular plate-like members. A stator 15 is disposed between the pump impeller 10 and the turbine runner 8, at a position circumferentially inward of the pump impeller 10 and the turbine runner 8, and this stator 15 is coupled, via a one-way clutch 17, to a fixed shaft 16 fitted to the outer circumference of the input shaft 6.

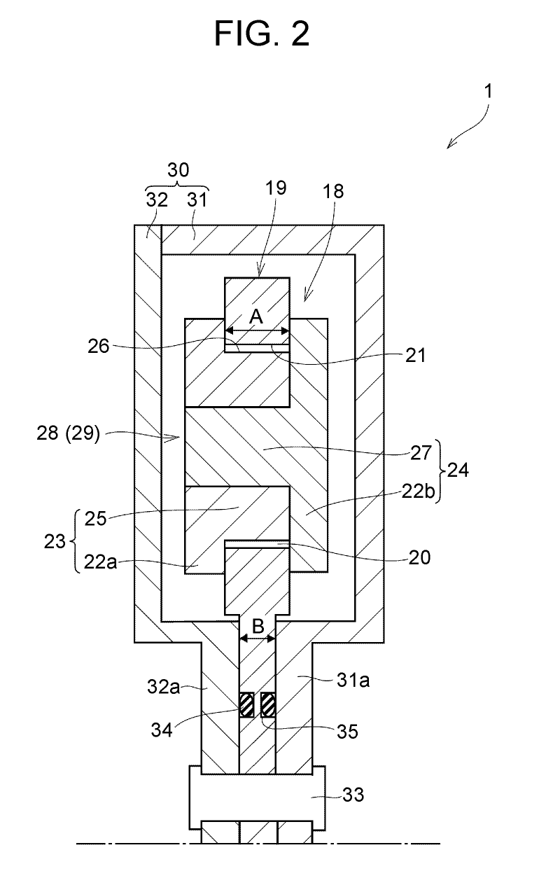

The pendulum torsional-vibration reducing device 1 is disposed between the turbine runner 8 and the lock-up clutch 9, or between the turbine runner 8 and the lock-up damper 11. FIG. 2 is a view schematically showing the first embodiment of this disclosure, as one example of the pendulum torsional-vibration reducing device 1. Specific description thereof will be provided hereinafter. The device shown in FIG. 2 is of a pendulum type, and at least one rolling element 18 that carries out pendular movement is held by a rotor 19. In an example shown in FIG. 2, the rotor 19 is an annular plate-like member, and rotates when receiving torque, and also generates torsion vibrations by fluctuations of the torque. This rotor 19 is fixed to a crankshaft of the engine 3 shown in FIG. 1, to a propeller shaft to transmit drive force to a not-illustrated wheel, or to a rotational member such as an axle with a rotational center line of the rotor 19 horizontally or laterally extending. The rotor 19 is formed with guide holes 20 long in the circumferential direction at positions greatly apart from the rotational center in the radial direction, and each guide hole 20 extends through the rotor 19 in its plate thickness direction.

The guide hole 20 is formed to have a proper shape and a proper dimension that allow the rolling element 18 disposed therein to roll within a predetermined region. Rolling means reciprocating movement or pendular movement, for example. The guide holes 20 correspond to one example of “through-holes” in this disclosure. The shape of the guide hole 20 may be a simple circular shape, other than a hole long in the circumferential direction, as described above. An inner wall surface of each guide hole 20 located at a radial outward position of the rotor 19 is defined as a rolling surface 21 on which the rolling element 18 performs pendular movement caused by torque fluctuations, that is, torsional vibrations of the rotor 19. The shape of the rolling surface 21 is an arc surface having a radius smaller than a dimension from the rotational center to the rolling surface 21, or a curved surface approximate to this arc surface. Note that a plurality of guide holes 20 are formed in the circumferential direction of the rotor 19 with predetermined intervals.

The rolling element 18 is an inertial mass body that carries out pendular movement by its inertial force when torque fluctuations of the rotor 19 occur. The rolling element 18 is a member formed in a shape, such as a cylindrical shape or a disk-like shape, having a circular section as viewed from the axial direction of the rotor 19 such that the rolling element 18 rolls along the above-described rolling surface 21. In the first embodiment, the rolling element 18 is formed to have a so-called H-shaped sectional shape, as shown in FIG. 2. With such a configuration, with flanges 22 (22a, 22b) on the both right and left ends coming into contact with both side surfaces of the rotor 19, the rolling element 18 can be suppressed from coming out from the guide holes 20 in the axial direction. As shown in FIG. 2, the rolling element 18 includes a first member 23 and a second member 24, and is configured by a divided structure.

Describing this structure, the first member 23 includes a shaft portion 25 in a hollow cylindrical shape and the flange portion 22a that is a first flange of the above-described H-shaped flanges. An axial length of the shaft portion 25 is so formed as to be longer than a plate-thickness (a length in the axial direction) of the rotor 19 and protrude from the guide hole 20. An outer diameter of the shaft portion 25 is configured to be slightly smaller than a dimension at a position where an opening width of the guide hole 20 in the radial direction of the rotor 19 is the smallest so that the rolling element 18 can roll on the rolling surface 21 without sliding on the inner wall surface of the guide hole 20. Hence, there is a gap between an outer circumferential surface 26 of the shaft portion 25 of the rolling element 18 and the inner wall surface of the guide hole 20. This outer circumferential surface 26 of the shaft portion 25 is a portion to be in contact with the rolling surface 21, and the outer circumferential surface 26 is pushed against the rolling surface 21 by centrifugal force. The flange portion 22a is integrated with the shaft portion 25 at a first end portion in the axial direction of the shaft portion 25 so as to protrude more radially outward than the shaft portion 25. An outer diameter of the flange portion 22a is formed to be greater than the outer diameter of the shaft portion 25, and also greater than the opening width of the guide hole 20 in the radial direction of the rotor 19.

In the meantime, the second member 24 includes an shaft portion 27 having an outer diameter that is substantially the same as an inner diameter of the shaft portion 25 of the first member 23 having a hollow cylindrical shape. The second member 24 also includes the flange portion 22b that is a second flange of the flanges 22 having the above-described “H-shaped” sectional shape. An axial length of the shaft portion 27 is formed to be longer than a plate thickness of the rotor 19, and the outer diameter of the shaft portion 27 is substantially the same as an inner diameter of the shaft portion 25 of the first member 23, as above described. That is, the shaft portion 25 of the first member 23 includes a hollow cylindrical portion 28 that is recessed in the axial direction; and contrary to this, the shaft portion 27 of the second member 24 includes a columnar portion 29 to be pressedly or tightly fitted into this hollow cylindrical portion 28. The flange portion 22b is configured to face the above-described flange portion 22a. Similar to the flange portion 22a, the flange portion 22b is integrated with the shaft portion 27 at its second end portion in the axial direction of the shaft portion 27, and an outer diameter of the flange portion 22b is formed to be greater than the opening width of the guide hole 20 in the radial direction of the rotor 19.

In order to prevent the pendular movement of the rolling element 18 from being hindered by the fluid such as oil in the torque converter 2, the rolling element 18 and a region where the rolling element 18 carries out the pendular movement are sealed in a liquid tight condition. That is, a portion of the rotor 19 ranging from its intermediate part to its outer circumferential end in the radial direction is covered in a liquid tight condition by a casing 30. In other words, the above portion of the rotor 19 is covered by the casing 30 so as to be shut off from the oil in the torque converter 2. This casing 30 is composed by a first case member 31 and a second case member 32, and has a rectangular section as a whole. The case members 31, 32 cover the rolling element 18 and the region where the rolling element 18 carries out the pendular movement with center parts of the case members 31, 32 expanding in the right and left direction in FIG. 2 in such a manner that the case members 31, 32 do not come into contact with both the rolling element 18 and the region where the rolling element 18 carries out the pendular movement. In each of the case members 31, 32, an end portion of each case member located on the outer side in the radial direction of the rotor 19 (hereinafter, referred to as an “outer circumferential end portion”) defines a plane that divides the casing 30. The outer circumferential end portion of the first case member 31 covers an outer circumferential end surface of the rotor 19, and extends toward the second case member 32 side. Then, both outer circumferential ends of the case members 31, 32 are joined to be integrated with each other by appropriate joining means such as welding.

In the above casing 30, the case members 31, 32 respectively include a fixing piece 31a and a fixing piece 32a that are brought to be in tight contact with the both side surfaces of the rotor 19 at an inward position in the radial direction of the rotor 19 so as to hold the rotor 19 therebetween. The fixing pieces 31a, 32a are fastened by a rivet 33 extending through the fixing pieces 31a, 32a and the rotor 19 in the thickness direction in a state in which the fixing pieces 31a, 32a are in tight contact with the rotor 19 along the side surface of the rotor 19. This means that the rotor 19 and the fixing pieces 31a, 32a in the casing 30 are integrated all together by this rivet 33. This rivet 33 corresponds to one example of a “fastening member” in this disclosure. In addition, a seal member is interposed and held between the fixing piece 31a and the side surface of the rotor 19 and between the fixing piece 32a and the side surface of the rotor 19. This seal member seals the region where the rolling element 18 carries out the pendular movement so as to prevent the oil from flowing into this region. In the example shown in FIG. 2, the seal member is composed by an O ring 34. More specifically, a groove portion 35 is formed in the rotor 19, and the O ring 34 is provided in this groove portion 35 so as to maintain the inside of the casing 30 in a liquid tight condition relative to the oil in the outside of the casing 30.

Furthermore, in the first embodiment, as shown in FIG. 2, it is configured that the thickness of the rotor 19, that is a dimension in the axial direction of the rotor 19 is changed between a position where the rolling surface 21 on which the rolling element 18 rolls is formed and a position held between the aforementioned fixing pieces 31a, 32a. Specifically, the rotor 19 is formed with a step such that the thickness of the rotor 19 is changed in the vicinity of a position where the part covered with the casing 30 is switched to the position where the rotor 19 is held between the fixing pieces 31a, 32a. In addition, the rotor 19 is formed such that a thickness A of the rotor 19 at the position where the rolling surface 21 is formed is thicker than a thickness B of the rotor 19 at the position where the rotor 19 is held between the fixing pieces 31a, 32a. Because the rolling element 18 is pushed against the rolling surface 21 by centrifugal force caused by rotation of the rotor 19, it is configured that the thickness A (a thicker-thickness portion) of the rotor 19 at the position where the rolling surface 21 is formed has a thickness corresponding to a contact area or a contact width with the rolling element 18.

In the meantime, at the thickness B (a thinner-thickness portion) of the rotor 19 at the position where the rotor 19 is held between the fixing pieces 31a, 32a, required rigidity or strength is smaller than that in the thickness A of the rotor 19 at the position where the above rolling surface 21 is formed. That is, the above force pushing the rolling element 18 by the centrifugal force tends not to be directly applied to the rotor 19 at the position held between the fixing pieces 31a, 32a; therefore, the rotor 19 is formed such that the thickness B of the rotor 19 is thinner than the thickness A at the position where the rolling surface 21 is formed. The portion held between the fixing pieces 31a, 32a is caulked and fixed by the above-described rivet 33; thus rigidity and strength are secured by this fixing.

The thickness A of the rotor 19 at the position where the rolling surface 21 is formed is formed to be thicker than the thickness B of the rotor 19 at the position held between the fixing pieces 31a, 32a, but the thickness A is also formed to be thinner than a total thickness including the thickness B of the rotor 19 and the fixing pieces 31a, 32a. Addition to this, the above portion of the rotor 19 is formed such that an axial dimension (thickness) of the rotor 19 is shorter than a length of the rivet 33.

Furthermore, the rotor 19 including those portions whose thicknesses are different is produced through pressing such that an overall thickness of the entire rotor 19 becomes the thickness A of the rotor 19 at the position of the rolling surface 21, and then through cutting or pressing to form the thickness B of the rotor 19 at the position held between the fixing pieces 31a, 32a. Through this, wall-thickness reduction of the rotor 19 is attained.

In this manner, the rotor 19 in the first embodiment is configured such that the thickness B of the rotor 19 at the position held between the fixing pieces 31a, 32a is set to be thinner than the thickness A of the rotor 19 at the position where the rolling surface 21 is formed. That is, the thickness B of the rotor 19 at the position where the O ring 34 is provided, or at the position where the fixing pieces 31a, 32a and the rotor 19 are fastened by the rivet 33 is set to be thinner than the thickness A of the rotor 19 at the position of the rolling surface 21. Hence, for example, compared with the above configuration described in JP 2016-011668 A, it is possible to reduce the length of the rivet 33, thus cost reduction and weight reduction of the rivet 33 can be promoted. The length of the rivet 33 can be reduced in the above manner, so that a space generated by that reduced length can effectively be used. Therefore, it is also possible to reduce the entire axial length of the pendulum torsional-vibration reducing device 1.

By reducing the thickness B of the rotor 19 at the position held between the fixing pieces 31a, 32a in the above manner, the mass of the rotor 19 can be reduced by that reduced thickness of the thickness B of the rotor 19. Therefore, it is possible to reduce the total mass of the pendulum torsional-vibration reducing device 1. In addition, by that reduced thickness of the thickness B of the rotor 19, a ratio of the rolling element 18 as an inertial mass body relative to the total mass of the pendulum torsional-vibration reducing device 1 becomes increased, or by that reduced thickness of the thickness B of the rotor 19, it is possible to promote enhancement of the vibration reducing performance by increasing the mass of the rolling element 18. Addition to this, the mass of the rolling element 18 can be increased, to thereby enhance the rolling performance of the rolling element 18 so that the rolling element 18 stably rolls on the rolling surface 21.

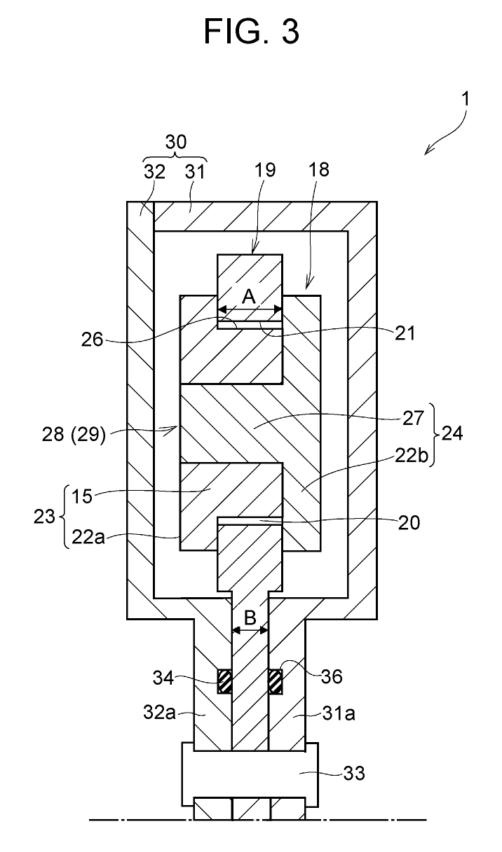

Next, the second embodiment of this disclosure will be described. In the aforementioned embodiment shown in FIG. 2, it is configured that the rotor 19 is formed with the groove portion 35, and the O ring 34 is provided in this groove portion 35, to thereby maintain the inside of the casing 30 in a liquid tight condition relative to the oil outside the casing 30. In the meantime, in the second embodiment, as shown in FIG. 3, a groove portion 36 may be formed in the casing 30, that is, in the fixing pieces 31a, 32a, and the O ring 34 may be provided in this groove portion 36. The other configurations are the same as those shown in FIG. 2, and thus description of the configurations will be omitted, and the same reference numerals are added thereto.

In the embodiment shown in FIG. 3, the same operation and effect as those of the example shown in FIG. 2 can be attained. According to the second embodiment shown in FIG. 3, since the groove portion 36 is formed in the fixing pieces 31a, 32a, the thickness B of the rotor 19 at the position held between the fixing pieces 31a, 32a can be further reduced, compared with the reduced thickness in the example shown in FIG. 2. Accordingly, it is possible to further reduce the length of the rivet 33, to thus promote cost reduction and weight reduction thereof. Addition to this, it is also possible to reduce the entire axial length of the pendulum torsional-vibration reducing device 1, and it is also possible to reduce the total mass of the pendulum torsional-vibration reducing device 1.

In the thickness A and the thickness B of the rotor 19 in each of the above embodiments shown in FIG. 2 and FIG. 3, the thickness A of the rotor 19 at the position where the rolling surface 21 is formed is set to be a thickness that can secure a predetermined rigidity defined by considering that the rolling element 18 is pushed against the rolling surface 21 by the centrifugal force due to the rotation of the rotor 19. The thickness B of the rotor 19 at the position held between the fixing pieces 31a, 32a is set to be a thickness that can secure a predetermined rigidity defined by considering that the rotor 19 is fastened by the rivet 33.

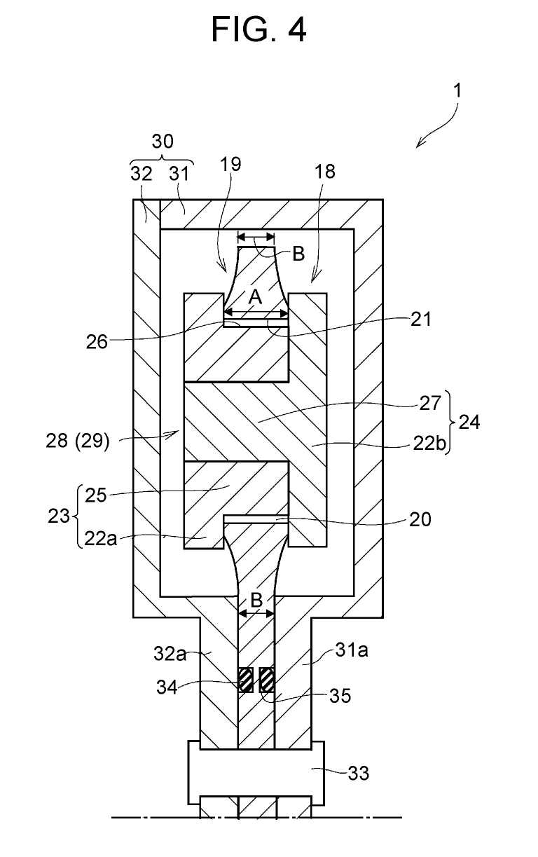

As aforementioned, the embodiments of this disclosure have been described, but this intention is not limited to the above examples, and may be appropriately changed within the scope of the object of this disclosure. In the above-described embodiments, the rotor 19 is configured such that the thickness B at the position held between the fixing pieces 31a, 32a is thinner than the thickness A at the position where the rolling surface 21 is formed. In the meantime, the rotor 19 may be configured such that, while the above-described rigidity and strength are secured, at least the thickness at the position where the rolling surface 21 is formed is set to be a thickness corresponding to the contact area or the contact width with the rolling element 18. Therefore, for example, as shown in FIG. 4, in the rotor 19, a thickness of the rotor 19 at a position located more circumferentially outward than the position where the rolling surface 21 is formed may be configured to be thinner than the thickness of the rotor 19 at the position where the rolling surface 21 is formed, as far as rigidity and strength are secured. Specifically, in the portion of the rotor 19 located more circumferentially outward than the position of the rotor 19 where the rolling surface 21 is formed, a part of the portion of the rotor 19 ranging from a position located more circumferentially inward than outer circumferential edges of the flange portions 22a, 22b to the outer circumferential edge of the rotor 19, is set to have a thinner thickness than the thickness A at the position where the rolling surface 21 is formed. In a portion of the rotor 19 located more radially inward than the guide holes 20, a part of the portion of the rotor 19, ranging from a position more circumferentially inward than the outer circumferential edges of the flange portions 22a, 22b of the rolling element 18 to the position of the rotor 19 held between the fixing pieces 31a, 32a of the rolling element 18, is set to have a thinner thickness than the thickness A at the position where the rolling surface 21 is formed. In other words, in the axial direction of the rotor 19, the thicknesses of the portions of the rotor 19 where the rotor 19 and the flange portions 22a, 22b do not overlap with each other (the portions of the rotor 19 that are not held between the flange portions 22a, 22b) are thinner than the thickness of the rotor 19 at the position where the rolling surface 21 is formed. The thickness of the rotor 19 is formed to be gradually thinner from the rolling surface 21 side toward the outer circumferential edge of the rotor 19, and be also gradually thinner toward the radially inward side of the rotor 19 from the guide hole 20 side. In the example shown in FIG. 4, the rotor 19 at a position having the smallest thickness in the thickness ranging to the outer circumferential edge of the rotor 19 is set to have the same thickness as the thickness B at the position held between the fixing pieces 31a, 32a.

In this manner, by setting the thickness of the part of the portion of the rotor 19, ranging from a position located more circumferentially inward than the outer circumferential edges of the flange portions 22a, 22b to the outer circumferential edge of the rotor 19, to be thinner, even when the rolling element 18 vibrates or is inclined in the thickness direction of the rotor 19, for example, it is possible to suppress or avoid the contact between the rotor 19 and the rolling element 18, to thereby suppress or avoid hindrance of the pendular movement of the rolling element 18 and deterioration of the vibration reducing performance. In the variation shown in FIG. 4, since the thickness of the rotor 19 becomes gradually thinner, there is no step at which the thickness of the rotor 19 is changed, unlike the aforementioned embodiments shown in FIG. 2 and FIG. 3. Hence, stress concentration can be prevented. Additionally, bending or buckling caused by the stress concentration can be suppressed, thus enhancing durability. In the variation shown in FIG. 4, the other configurations are the same as those of the embodiment shown in FIG. 2, and thus description thereof will be omitted, and the same reference numerals are added thereto.

Furthermore, in the aforementioned embodiments, the rivet 33 is described as an example of the fastening member. However, other fastening members, such as bolts, may be used instead of the rivet 33. In addition, the seal member is not limited to the O ring 34, and may be any member or any configuration as far as the inside of the casing 30 can be maintained in a liquid tight condition relative to the oil outside the casing.

In the aforementioned embodiments, the rolling element 18 is constituted by the first member 23 and the second member 24. However, the rolling element 18 may be configured, for example, by two or more members further including other members. Addition to this, in the embodiments shown in FIG. 2 to FIG. 4, the rolling element 18 is configured to have the flange portions 22a, 22b on the both ends of the shaft portion 25 so as to have an “H-shaped” section. However, the flange portion 22a (22b) may be formed at only one end of the shaft portion 25. In the embodiments shown in FIG. 2 and FIG. 3, one step for changing the thickness of the rotor 19 is formed so as to change the thickness of the rotor 19, but a plurality of steps, such as two or three steps, may be formed in order to change this thickness. This means that the configuration may be appropriately changed as far as rigidity and strength can be secured, and at the same time, weight reduction and cost reduction of the rotor 19 and the fastening member such as the rivet 33 can be attained, and the vibration reducing performance can also be enhanced.

What is claimed is:

1. A pendulum torsional-vibration reducing device comprising:
a rotor that is rotatable, the rotor having a plurality of through-holes formed in the rotor, the plurality of through-holes being formed with predetermined intervals in a circumferential direction of the rotor;
a rolling element disposed in the through-holes so as to carry out pendular movement; and
a casing fixed to the rotor so as to cover the rolling element, wherein:
the casing includes fixing pieces, the fixing pieces being in tight contact with both side surfaces of the rotor so as to hold the rotor between the fixing pieces;
the rotor has a rolling surface against which the rolling element is pushed by centrifugal force;
the rotor includes a first portion where the rolling surface is formed, and a second portion with which the fixing pieces are in tight contact; and
a thickness at the second portion is thinner than a thickness at the first portion.

2. The pendulum torsional-vibration reducing device according to claim 1, further comprising a fastening member that fixes the fixing pieces to the rotor, wherein:
the fastening member extends through the fixing pieces and the rotor in a thickness direction; and
the fastening member integrally fastens the fixing pieces and the rotor all together.

3. The pendulum torsional-vibration reducing device according to claim 2, wherein at a position where the fixing pieces and the rotor are integrally fastened by the fastening member, a total thickness of a thickness of the fixing pieces and a thickness of the rotor is thicker than the thickness at the first portion.

4. The pendulum torsional-vibration reducing device according to claim 1, wherein:
a seal member is interposed between the fixing pieces and the rotor; and
the seal member seals a part between the fixing pieces and the rotor.

5. The pendulum torsional-vibration reducing device according to claim 1, wherein:
the rolling element includes a shaft portion and a flange portion;
a length of the shaft portion is larger or equal to the thickness at the first portion;
the flange portion is at least provided at one end of the shaft portion;
an outer diameter of each flange portion is greater than an outer diameter of the shaft portion; and
in an outward portion being a portion of the rotor located more circumferentially outward than the first portion, a thickness of a part of the outward portion where the rotor and the flange portion do not overlap with each other is thinner in an axial direction of the rotor than the thickness at the first portion.

6. The pendulum torsional-vibration reducing device according to claim 5, wherein in an inward portion being a portion of the rotor located more circumferentially inward than the through-holes, a part of the inward portion where the rotor and the flange portion do not overlap with each other has a thickness gradually thinner toward a radially inward direction of the rotor.
